(19) United States
(12) Patent Application Publication
(10) Pub. No.: US 2003/0163315 A1
(43) Pub. Date: Aug. 28, 2003

(54) Method and system for generating caricaturized talking heads

(75) Inventors: Kiran Challapali, New City, NY (US); George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/084,710

(22) Filed: Feb. 25, 2002

(51) Int. Cl. G10L 13/08

(52) U.S. Cl. 704/260

(57) ABSTRACT

A method and system are disclosed for generating talking heads in text-to-speech synthesis applications that provides for modifying an input image to be more appealing to a viewer. The modified images may be at least in part caricatures (i.e., somehow synthetic). The caricatures may be created using either a manual or an automatic method with filters.

### FIELD OF THE INVENTION

The present invention relates to the field of facial images. More particularly, the invention relates to a method and system for generating talking heads in text-to-speech synthesis applications that provides for modifying an input facial image to be more appealing to a viewer.

### BACKGROUND OF THE INVENTION

In text-to-audio-visual-speech (“TTAVS”) systems, the integration of a “talking head,” can be used for a variety of applications. Such applications may include, for example, model-based image compression for video telephony, presentations, avatars in virtual meeting rooms, intelligent computer-user interfaces such as E-mail reading and games, and many other operations. An example of such an intelligent user interface is an E-mail system that uses a talking head to express transmitted E-mail messages. The sender of the E-mail message could annotate the E-mail message by including emotional cues with or without text. In this regard, a user may send a congratulatory E-mail message to another person in the form of a happy face. Other emotions such as sadness, anger, or disappointment can also be emulated.

To achieve desired effects, an animated head must be believable, i.e., realistic looking, to the viewer. Both photographic aspects of a face (e.g., natural skin appearance, absence of rendering artifacts, and realistic shapes), as well as life-like quality of the animation (e.g., realistic lip and head movements in synchronization with the audio being played) must be considered because people are sensitive to the movement and appearance of human faces. When well-done visual TTAVS can be a power tool to grab the observer's attention. This provides a user with a sense of realism to which the user can relate.

Various conventional approaches exist for realizing audio-visual TTAVS synthesis algorithms, e.g., simple animation/cartoons may be used. Generally, the more detailed the animation used, the greater the impact on the viewer. Nevertheless, because of their obviously artificial look, cartoons have a very limited effect. Another conventional approach for realizing TTAVS methods uses video recordings of a talking person. These recordings are then integrated into a computer program. The video approach is more realistic than cartoons animation. The utility of the video approach, however, is limited to situations where the spoken text is known in advance and where sufficient storage space exists in memory for the video clips. These situations generally do not exist commonly employed TTAVS applications.

Three-dimensional (3D) modeling techniques can also be used for many TTAVS applications. Such 3D models provide flexibility because the models can be altered to accommodate different expressions of speech and emotions. Unfortunately, these 3D models are usually not suitable for automatic realization by a computer system. The programming complexities of 3D modeling are increasing as present models are enhanced to facilitate greater realism. In such 3D modeling techniques, the number of polygons used to generate 3D synthesized scenes has grown exponentially. This greatly increases the memory requirements and computer processing power.

As discussed above, cartoons offer little flexibility because the cartoon images are all predetermined and the speech to be tracked must be known in advance. In addition, cartoons are the least realistic-looking approach. While video sequences are realistic, they have little flexibility because the sequences are all predetermined. Three-dimensional modeling is flexible because of the fully synthetic nature. Such 3D models can represent any facial appearance or perspective. However, the complete synthetic nature of such 3D models lowers the perspective of realism.

Image-based techniques allow for a substantial amount of realism and flexibility. Such techniques look realistic because facial movements, shapes, and colors can be approximated with a high degree of accuracy. In addition, video images of live subjects can be used to create the image-based models. Image-based techniques are also flexible because a sufficient amount of samples can be taken to exchange head and facial parts to accommodate a wide variety of speech and emotions.

In such image-based systems, a set of N (e.g., 16) photographs of a person uttering phonemes that result in unique mouth shapes (or visemes) are used. In TTAVS systems, text is processed to get phonemes and timing information, which is then passed, to a speech synthesizer and a face animation synthesizer. The face animation synthesizer uses an appropriate viseme image (from the set of N) to display with the phoneme and morphs from one phoneme to another. This conveys the appearance of facial movement (e.g., lips) synchronized to the audio. Such conventional systems are described in “Miketalk: A talking facial display based on morphing visemes,” T. Ezzat et al., Proc Computer Animation Conf. pp. 96-102, Philadelphia, Pa., 1998, and “Photo-realistic talking-heads from image samples,” E. Cosatto et al., IEEE Trans. On Multimedia, Vol. 2, No. 3, September 2000.

However, one significant shortcoming of the conventional image-based systems discussed above is that the user may have a perceptional mismatch between the image displayed and the synthetic speech or audio that is played. This is because the image is photo-realistic while the speech sounds synthetic (i.e., computer-generated or robot-like).

### SUMMARY OF THE INVENTION

Accordingly, an object of the invention is to provide a technique for TTAVS systems to match the viewer perceptions regarding the displayed image and the synthetic speech that is played.

Another object of the invention is to be able to generate caricaturized talking head images and audio for a text-to-speech application that can be implemented automatically by a computer, including a personal computer.

Another object of the invention is to disclose a caricaturing filter for modifying image-based samples that can be used in a conventional TTAVS environment.

Another object of the invention is to provide an image-based method for generating talking heads in TTAVS applications that is flexible.

These and other objects of the invention are accomplished in accordance with the principles of the invention by providing a image-based method for synthesizing talking heads in TTAVS applications in which viseme images (i.e., images) of a person are processing to give the impression that the viseme image are at least in part caricatures (i.e., somehow synthetic). The caricatures may be created using either a manual or an automatic method with filters. The style of the caricature can be, for example, watercolor, comic, palette knife, pencil, fresco, etc. By using caricatured images, a TTAVS system is more appealing to a viewer, since both the audio and the visual part of the system have at least a partial synthetic feeling while maintain image realism.

One embodiment of the present invention is directed to an audio-visual system including a display capable of displaying a talking head, an audio synthesizer unit, and a caricature filter. A processor is arranged to control the operation of the audio-visual system. Before the talking head is displayed by the display, the caricature filter processes it.

Another embodiment of the present invention is directed to a method for creating a talking head image for a text-to-speech synthesis application. The method includes the steps of sampling images of a talking head, decomposing the sampled images into segments and rendering the talking head image from the segments. The method also includes the step of applying a caricature filter to the talking head image.

Yet another embodiment of the present invention is directed to an audio-visual system means for displaying a talking head. The talking head is initially formed using images of a subject. The system also includes means for synthesizing audio and a caricature filter. The filter modifies the appearance of the talking head before the talking head is displayed by the means for displaying. The modified talking head has at least partially an artificial appearance as compared to an unmodified talking head formed using the images of the subject.

Still further features and aspects of the present invention and various advantages thereof will be more apparent from the accompanying drawings and the following detailed description of the preferred embodiments.

### BRIEF DESCRIPTION OF THE DRAWINGS

FIG. 1 shows a conceptual diagram of a system in which a preferred embodiment of the present invention can be implemented.

FIG. 2 shows a flowchart describing an image-based method for generating caricaturized talking head images in accordance with a preferred embodiment of the invention.

FIG. 3 shows examples of caricatured images according to several embodiments of the present invention.

### DETAILED DESCRIPTION OF THE INVENTION

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for purposes of simplicity and clarity, detailed descriptions of well-known devices, circuits, and methods are omitted so as not to obscure the description of the present invention with unnecessary detail.

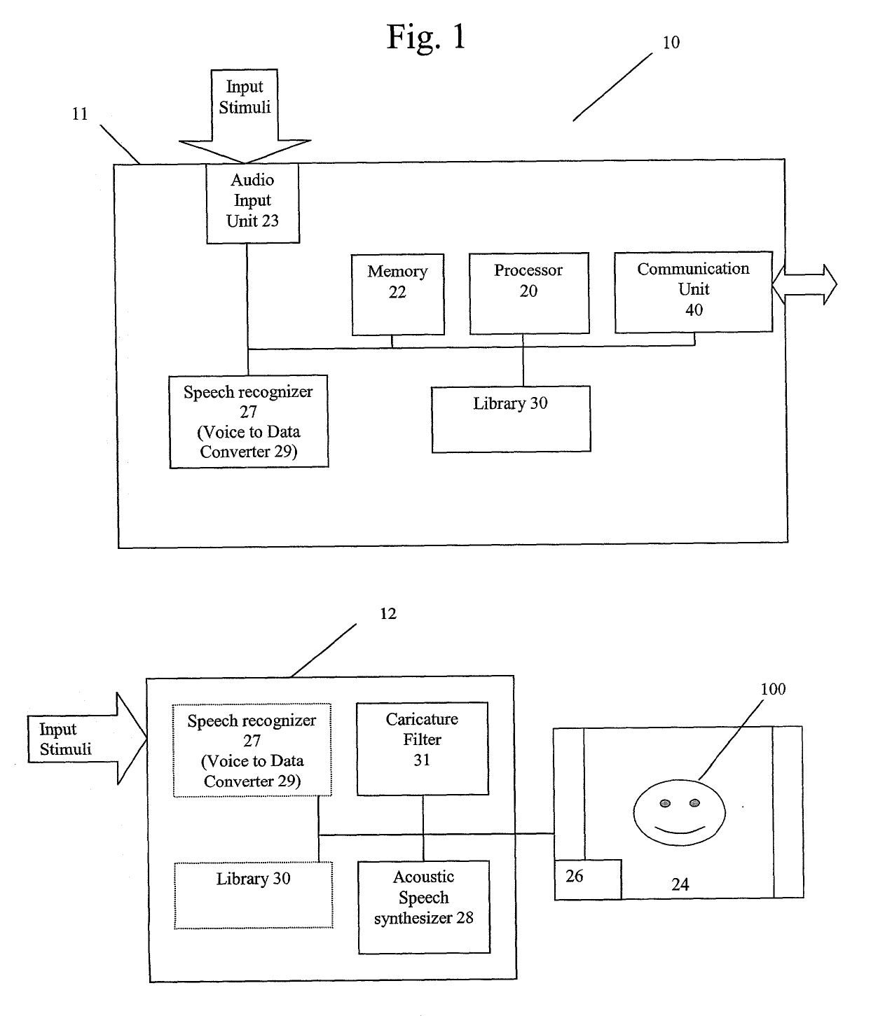

FIG. 1 shows a conceptual diagram describing exemplary physical structures in which the embodiments of the invention can be implemented. This illustration describes the realization of a method using elements contained in a personal computer. The method can be implemented by a variety of means in both hardware and software, and by a wide variety of controllers and processors. For example, it is noted that a laptop or palmtop computer, a personal digital assistant (PDA), a telephone with a display, television, set-top box or any other type of similar device may also be used.

The system 10 shown in FIG. 1 includes a creation system 11 that includes a processor 20 and a memory 22. The processor 20 may represent, e.g., a microprocessor, a central processing unit, a computer, a circuit card, an application-specific integrated circuit (ASICs). The memory 22 may represent, e.g., disk-based optical or magnetic storage units, electronic memories, as well as portions or combinations of these and other memory devices.

Audio (e.g., a voice) is input into an audio input unit 23 (e.g., a microphone or via a network connection). The voice provides the input that will ultimately be tracked by a talking head 100. The creation system 11 is designed to create a library 30 to enable drawing of a picture of the talking head 100 on a display 24 (e.g., a computer screen) of an output element 12, with a voice output, via an audio output unit 26, corresponding to input stimuli (e.g., audio) and synchronous with the talking head 100.

As shown in FIG. 1, the output element 12 need not be integrated with the creation system 11. (The boxes representing the speech recognizer 27 and the library 30 in the output element 12 are shown dashed to illustrate that they need not be duplicated if an integrated configuration is used.) The output element 12 may be removably connected or coupled to the creation system 11 via a data connection. A non-integrated configuration allows the library building and animation display functions to be separate. It should also be understood that the output element 12 may include its own processor, memory, and communication unit that may perform similar functions as described herein with regard to the processor 20, the memory 22 and the communication unit 40.

A variety of input stimuli (in place of the audio mentioned above), including text input in virtually any form, may be contemplated depending on the specific application. For example, the text input stimulus may instead be a stream of binary data. The audio input unit 23 may be connected to speech recognizer 27. In this example, speech recognizer 27 also functions as a voice to data converter, which transduces the input voice into binary data for further processing. The speech recognizer 27 is also used when the samples of the subject are initially taken.

In the output element 12, the audio which tracks the input stimulus is generated in this example by an acoustic speech synthesizer 28, which coverts an audio signal from a voice-to-data converter 29 into voice. The speech recognizer 27 may not be needed in the output element 12 if only text is to be used as the input stimuli.

For image-based synthesis, samples of sound, movements and images are captured while a subject is speaking naturally.

The samples capture the characteristics of a talking person, such as the sound he or she produces when speaking a particular phoneme, the shape his or her mouth forms, and the manner in which he or she articulates transitions between phonemes. The image samples are processed and stored in a compact animation library (e.g., the memory 22).

Various functional operations associated with the system 10 may be implemented in whole or in part in one or more software programs stored in the memory 22 and executed by the processor 20. The processor 20 considers text data output from the speech recognizer 27, recalls appropriate samples from the libraries in memory 22, concatenates the recalled samples, and causes a resulting animated sequence to be output to the display 24. The processor 20 may also have a clock, which is used to timestamp voice and image samples to maintain synchronization. Time stamping may be used by the processor 20 to determine which images correspond to which sounds spoken by the synthesized talking head 100.

The library 30 may contain at least an animation library and a coarticulation library. The data in one library may be used to extract samples from the other. For instance, the processor 20 may use data extracted from the coarticulation library to select appropriate frame parameters from the animation library to be output to the display 24. The memory 22 may also contain animation-synthesis software executed by the processor 20.

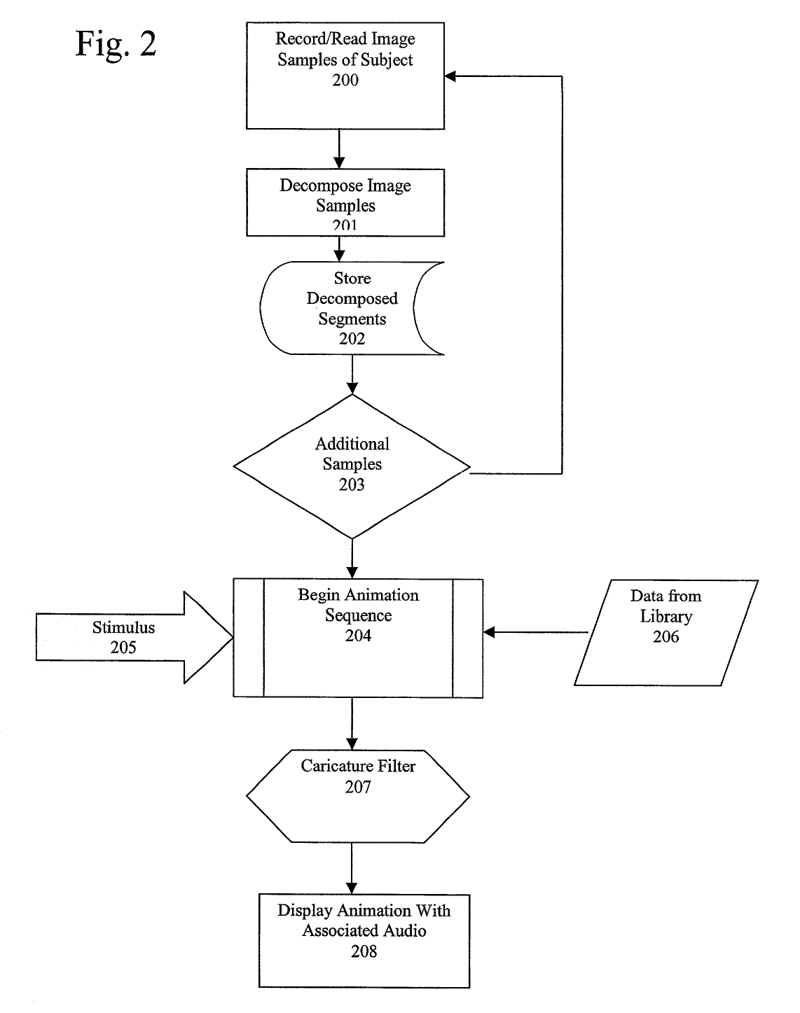

FIG. 2 shows a flowchart describing an image-based method for synthesizing photo realistic talking heads in accordance with a preferred embodiment of the invention. The method begins with recording a sample of a human subject (step 200). The recording step (200), or the sampling step, can be performed in a variety of ways, such as with video recording, computer generation, etc. The sample may be captured in video and the data is transferred to a computer in binary. The sample may comprise an image sample (i.e., picture of the subject), an associated sound sample, and a movement sample. It should be noted that a sound sample is not necessarily required for all image samples captured. For example, when generating a spectrum of mouth shape samples for storage in the animation library, associated sound samples are not necessary in some embodiments.

Next, in step 201, the image sample is decomposed into a hierarchy of segments, each segment representing a part of the sample (such as a facial part). Decomposition of the image sample is advantageous because it substantially reduces the memory requirements when the animation sequence is implemented. The decomposed segments are stored in an animation library (step 202). These segments will ultimately be used to construct the talking head 100 for the animation sequence.

Additional samples (step 203) of a next image of the subject at a slightly different facial position such as a varied mouth shape is performed. This process continues until a representative spectrum of segments is obtained and a sufficient number of mouth shapes are generated to make the animated synthesis possible. The animation library is now generated, and the sampling process for the animation path is complete. To create an effective animation library for the talking head, a sufficient spectrum of mouth shapes must be sampled to correspond to the different phonemes, or sounds, which might be expressed in the synthesis. The number of different shapes of a mouth is actually quite small, due to physical limitations on the deformations of the lips and the motion of the jaw.

Another sampling method is to first extract all sample images from a video sequence of a person talking naturally. Then, using automatic face/facial features location, these samples are registrated so that they are normalized. The normalized samples are labeled with their respective measured parameters. Then, to reduce the total number of samples, vector quantization may be used with respect to the parameters associated with each sample.

It is also noted that coarticulation is also performed. The purpose of the coarticulation is to accommodate effects of coarticulation in the ultimate synthesized output. The principle of coarticulation recognizes that the mouth shape corresponding to a phoneme depends not only on the spoken phoneme itself, but also on the phonemes spoken before (and sometimes after) the instant phoneme. An animation method that does not account for coarticulation effects would be perceived as artificial to an observer because mouth shapes may be used in conjunction with a phoneme spoken in a context inconsistent with the use of those shapes.

In step 204, the animated sequence begins. Some stimulus, such as text, is input (step 205). This stimulus represents the particular data that the animated sequence will track. The stimulus may be voice, text, or other types of binary or encoded information that is amenable to interpretation by the processor as a trigger to initiate and conduct an animated sequence. As an illustration, where a computer interface uses the talking head 100 to transmit E-mail messages to a remote party, the input stimulus is the E-mail message text created by the sender. The processor 20 will generate the talking head 100 which tracks, or generates speech associated with, the sender's message text.

Where the input is text, the processor 20 consults circuitry or software to associate the text with particular phonemes or phoneme sequences. Based on the identity of the current phoneme sequence, the processor 20 consults the coarticulation library and recalls data needed for the talking head from the library (step 206).

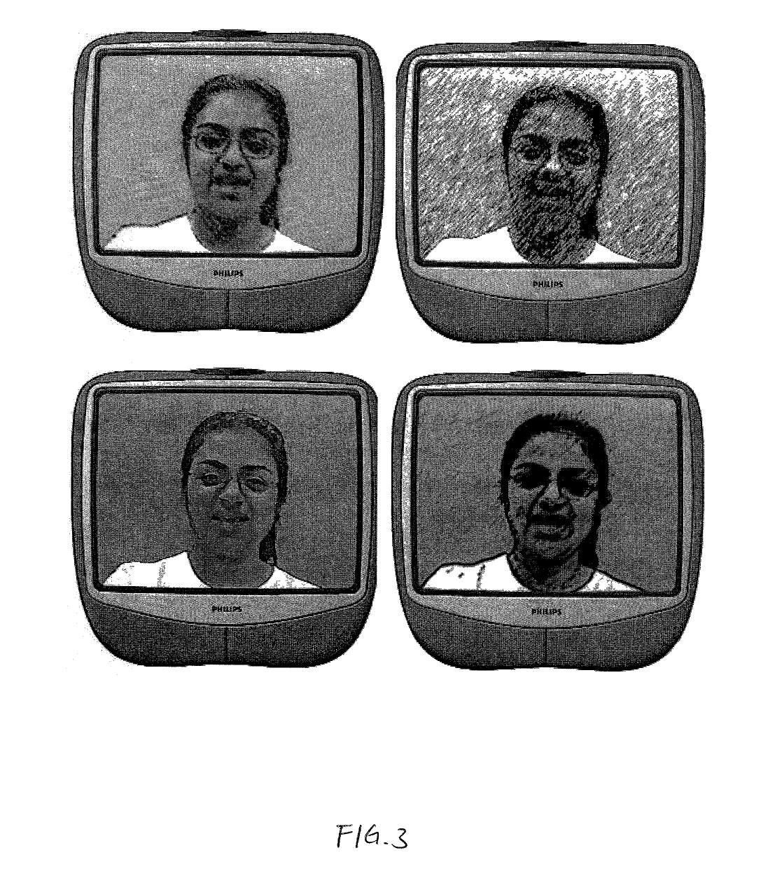

In step 207, the image data is supplied to a caricature filter 31 (shown in FIG. 1). The caricature filter 31 is used to modify the image data so that the displayed talking head 100 has at least in part a synthetic feeling. The caricatures filter process may be performed automatically or via a manual user input each time the talking head 100 is to be displayed. The style of the caricature can be, for example, watercolor, comic, palette knife, pencil, fresco, etc. FIG. 3 shows examples of the caricaturized talking heads using each of these filters. By using the caricatured talking head 100, a TTAVS system is more appealing to a viewer, since both the audio and the visual part of the system have at least a partial synthetic feeling while maintain image realism.

A user of the system 10, for example, may also change the appearance of the caricatured talking head 100 dynamically. In addition, user profiles may be created, and stored in the memory 22, that automatically set a preferred filter type (e.g., watercolor or fresco) for predetermined applications.

At this point (step 208), the animation process begins to display the talking head 100. Concurrent with the output of the talking head 100 to the display 24, the processor 20 uses audio stored in the coarticulation library to output speech to the audio output unit 26 that is associated with an appropriate phoneme sequence. The result is the talking head 100 that tracks the input data.

It should be noted that the samples of subjects need not be limited to humans. Talking heads of animals, insects, and inanimate objects may also be tracked according to the invention. It also noted that the image data to be used for the talking head 100 may be pre-stored or accessed via a remote data connection.

In one embodiment, the system 10 by represent an interactive TTAVS system can be an alternative for low bandwidth video-conferencing or informal chat sessions. This system incorporates a 3D model of a human head with facial animation parameters (emotion parameters) and speech producing capabilities (lip-sync). At the transmitter side, the user inputs text sentences via the keyboard, which are sent via a communication unit 40 (e.g., Ethernet, Bluetooth, cellular, dial-up or packet data interface) to the correspondent's PC. At the receiving end, the system converts incoming text into speech. The receiver sees a 3D head model—with appropriate facial emotions and lip movements—and hears speech corresponding to the text sent. The user can use a predefined set of symbols to express certain emotions, which in turn is reproduced at the receiving end. Thus, the chat session is enhanced, although the quality of high bandwidth video-conferencing cannot be reached.

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

What is claimed is:

1. An audio-visual system comprising:
a display capable of displaying a talking head;
an audio synthesizer unit;
a caricature filter; and
a processor arranged to control the operation of the audio-visual system,
wherein before the talking head is displayed by the display, the talking head is processed by the caricature filter.

2. The system of claim 1, wherein the talking head is based upon image sample of a subject.

3. The system of claim 2, wherein the caricature filter modifies the image sample to give an appearance of being at least partially synthetic as compared to an original image sample.

4. The system of claim 3, wherein the caricature filter is selected from the group consisting of watercolor, comic, palette knife, pencil, and fresco type filters.

5. The system of claim 1, further comprising a communication unit.

6. The system of claim 1, further comprising a speech recognizer and a voice-to-data converter coupled to the processor.

7. The system of claim 6, wherein the system is a text-to-audio-visual-speech system.

8. A method for creating a talking head image for a text-to-speech synthesis application, comprising the steps of:
sampling images of a talking head;
decomposing the sampled images into segments;
rendering the talking head image from the segments; and
applying a caricature filter to the talking head image.

9. The method according to claim 8, further comprising the step of displaying the caricaturized talking head.

10. The method according to claim 8, wherein the applying step includes applying a watercolor filter to the talking head image.

11. The method according to claim 8, wherein the applying step includes applying a comic filter to the talking head image.

12. The method according to claim 8, wherein the applying step includes applying a palette knife filter to the talking head image.

13. The method according to claim 8, wherein the applying step includes applying a pencil filter to the talking head image.

14. The method according to claim 8, wherein the applying step includes applying a fresco filter to the talking head image.

15. An audio-visual system comprising:
means for displaying a talking head, the talking head being initially formed using images of a subject;
means for synthesizing audio; and
a caricature filter that modifies an appearance of the talking head before the talking head is displayed by the means for displaying, the modified talking head having at least partially an artificial appearance as compared to an unmodified talking head formed using the images of the subject.

16. The system of claim 15, wherein the caricature filter is selected from the group consisting of watercolor, comic, palette knife, pencil, and fresco type filters.

17. The system of claim 15, wherein the caricature filter is selectively applied based upon user input.

18. The system of claim 15, wherein the caricature filter is automatically applied.

19. The system of claim 16, wherein a type of filter applied may be dynamically changed by a user.
